(19) United States
(12) Patent Application Publication
(10) Pub. No.: US 2006/0118725 A1
(43) Pub. Date: Jun. 8, 2006

(54) Mounting device provided with a part positioning system

(76) Inventors: Ralf Kurpjuweit, Achim-Baden (DE); Hubert Reinkunz, Neuhausen (DE); Wolhard Schmidt, Lilienthal (DE); Uwe Springer, Stuhr (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/534,241

(22) PCT Filed: Sep. 27, 2003
(86) PCT No.: PCT/EP03/10777

§ 371 Date: Nov. 10, 2005

(30) Foreign Application Priority Data
Nov. 9, 2002 (DE) 102 52 150.6

(51) Int. Cl. G01F 23/00

(52) U.S. Cl. 250/358.1

(57) ABSTRACT

The guiding device (10) is used to position at least one workpiece (12) and is provided with a workpiece position monitoring device (14). Provision is made here for the workpiece position monitoring device (14) to be designed as a sensor unit (16) for contactless workpiece position monitoring.

### BACKGROUND OF THE INVENTION

1. Field of the Invention

The invention relates to a guiding device for positioning at least one workpiece, comprising a workpiece position monitoring device, according to the preamble of claim 1.

2. Related Art of the Invention

Guiding devices of the type mentioned above are known. DE 40 23 428 A1 discloses a forced-guiding and centering device for a circular-segment rail of a rotary guide.

Furthermore, in traditional guiding devices of pressing units it is known for example to carry out workpiece position monitoring by means of mechanical contact devices. Such devices are prone to problems and are thus correspondingly unreliable.

### SUMMARY OF THE INVENTION

It is the object of the invention to provide a guiding device of the type mentioned above by means of which problem-free and reliable workpiece position monitoring can be carried out.

To achieve the object, a guiding device having the features of claim 1 is proposed. The guiding device according to the invention is distinguished in that the workpiece position monitoring device is designed as a sensor unit for contactless workpiece position monitoring. Such a sensor unit may, for example, contain at least one sensor according to document DE 298 20 742 U1. This document discloses a sensor which is used to detect a workpiece. The guiding device equipped according to the invention with a sensor unit is thus advantageously suitable for performing contactless component detection. This makes it possible to achieve problem-free and reliable workpiece position monitoring in the guiding device. Any signs of wear and/or contamination which may occur, in particular in workpiece contact regions of the guiding device, do not have a disadvantageous effect on component detection, which is now being carried out contactlessly by means of the sensor unit.

The workpiece position monitoring device is advantageously additionally designed as a centering and fixing device. Thus, the guiding device is suitable for centering, fixing and then, by means of the sensor unit, for registering a respective workpiece.

The guiding device is preferably part of a pressing unit or of a bodyshell-welding unit. Such a use of the guiding device is particularly advantageous for mass production, for example in corresponding automotive production plants.

The sensor unit may be an optical sensor unit, in particular an infrared sensor unit. Infrared light is particularly suitable for ensuring rapid and precise component recognition.

In accordance with a preferred embodiment, the sensor unit has a plurality of spaced-apart sensor elements. Preferably, at least two sensor elements arranged in a common plane are provided for workpiece position detection. In this arrangement, the workpiece can be fed in in this plane or perpendicularly thereto, for example from above. Depending on the direction of movement of the workpiece, the sensor element, which may if appropriate be provided with a guide bevel, can be arranged in a mounting location within the guiding device that promotes a correct workpiece position.

The sensor element is advantageously designed as a nondestructively replaceable structural element. This makes it possible in a simple manner to provide a variety of different sensor elements for use in the guiding device, the sensor elements being able to be tailored to the respective workpiece.

The sensor element advantageously in each case has an L-shaped workpiece contact side with which a sensor detection line forms a triangle. A sensor element designed in such a way can be used in a particularly flexible manner in a guiding device, since said sensor element allows the workpiece to be fed in from many directions.

According to a further, preferred embodiment, the sensor element has at least one hardened workpiece contact face. The workpiece contact face here preferably includes a guide bevel, by means of which centering of a workpiece to be positioned or to be fixed can be done relatively simply.

The sensor element may be a standard element, it being possible to provide different designs of sensor elements, such as a long and a short design, for example. A standard element is available relatively quickly in a workshop.

In a development of the invention, the sensor unit is connected to an electronic data processing device and/or to a control device. This allows automated and relatively quick workpiece position monitoring, and the monitoring time and/or the monitoring point for workpiece position detection may be preset in a variable manner if appropriate.

Further advantages of the invention will become apparent from the description.

### BRIEF DESCRIPTION OF THE DRAWINGS

The invention will be explained in greater detail by means of a preferred exemplary embodiment with reference to a schematic drawing, in which:

FIG. 1 shows a schematic perspective view of part of a guiding device according to the invention;

FIG. 2 shows a schematic side view of a sensor element of the guiding device of FIG. 1 on an enlarged scale;

FIG. 3 shows a schematic plan view of the sensor element of FIG. 2, and

FIG. 4 shows a schematic front view of a guide bevel of the sensor element of FIG. 2.

### DETAILED DESCRIPTION OF THE INVENTION

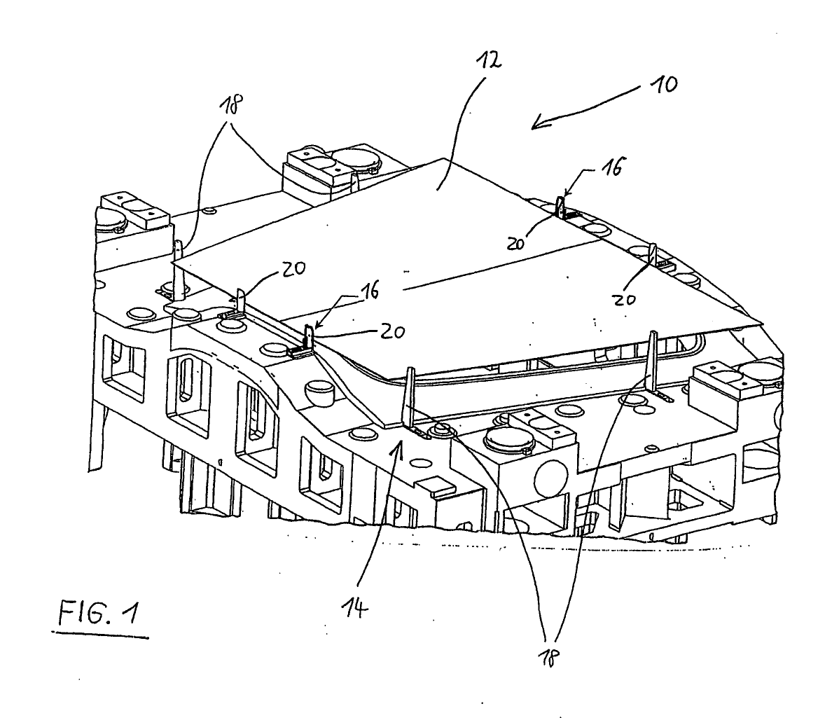

FIG. 1 is a schematic view showing a guiding device 10, for example of a forming machine of a pressing unit for automotive body parts (not shown in FIG. 1). The guiding device 10 is used to position a workpiece 12, in the present exemplary embodiment a blank 12 to be formed. For this purpose, the guiding device 10 is provided with a workpiece position monitoring device 14 which is designed as a sensor unit 16 for the purpose of contactless workpiece position monitoring. The sensor unit 16 is an optical sensor unit and preferably an infrared sensor unit in the present exemplary embodiment. It has four spaced-apart sensor elements 20 arranged in a common plane, with the sensor elements 20 being arranged in pairs on opposite sides of the blank. However, it is also possible to conceive of other types of arrangements of the sensor elements 20 on the sides of the blank. The guiding device 10 has a plurality of stop elements 18 which are also arranged on sides of the blank but which do not perform a workpiece position detection function; instead, they are used solely for centering and, if appropriate, fixing the blank 12. The number of sensor elements 20 which are used in the guiding device 10 for workpiece position detection can be preset in a variable manner.

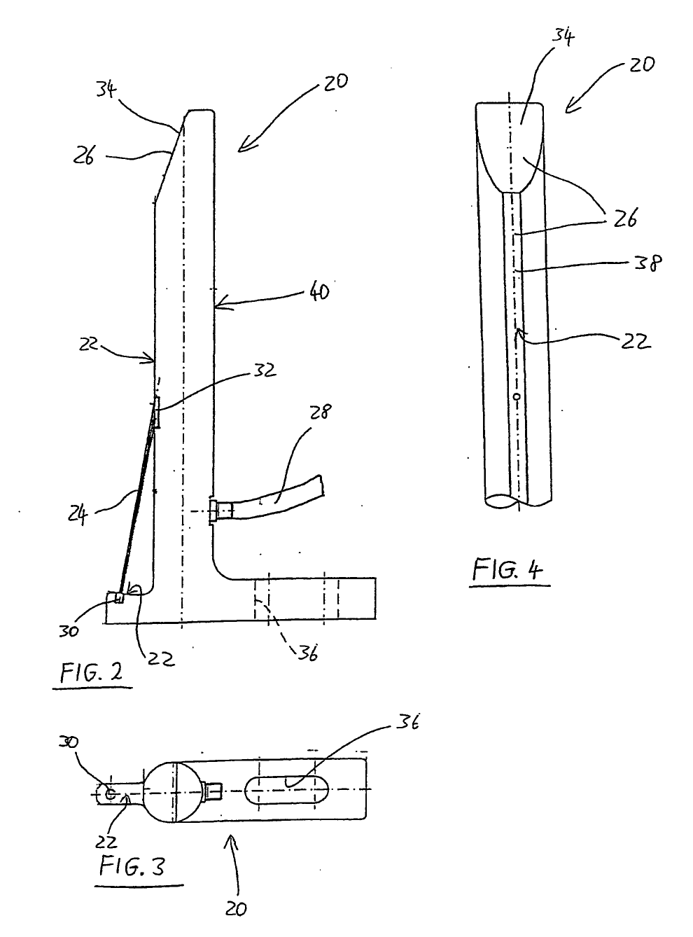

FIGS. 2 to 4 show different schematic views of a possible embodiment of the sensor element 20. The sensor element 20 has a substantially L-shaped workpiece contact side 22. A transmitter 30 and a receiver 32 are arranged on the workpiece contact side 22 in such a way that a sensor detection line 24 forms a triangle with the workpiece contact side 22. This sensor detection line 24 corresponds to a beam of infrared light which, during operation, is sent from the transmitter 30 to the receiver 32 in order to detect the position of the workpiece. On its workpiece contact side 22 the sensor element 20 has two hardened workpiece contact faces 26, one workpiece contact face 26 being designed as a planar guide bevel 34 (angle of inclination preferably about 20°) and the other workpiece contact face 26 being designed as a planar stop face 38. Hence, the sensor element 20 is also used at one and the same time for centering and fixing a blank 12 to be positioned. The sensor element 20 can be fixed in the guiding device 10 in a nondestructively replaceable manner and is provided for this purpose with a slot 36 on its likewise substantially L-shaped fastening side 40. By means of a suitable electrical lead 28, the sensor element 20 can be connected to a power source and also to an electronic data processing device and/or to a control device (not shown in the figures). Since the sensor element 20 is a standard element, it can also be integrated without problem in a pre-existing guiding device 10, for example as a replacement for previously provided stop elements 18 and/or for traditional mechanical part-position monitoring elements.

By means of such an optoelectronic sensor unit 16, the guiding device 10 can be operated with increased process reliability, since any signs of wear and/or contamination which may occur do not negatively affect the process as is the case with traditional mechanical sensor units.

1. A guiding device (10) for positioning at least one workpiece (12), comprising a workpiece position monitoring device (14), wherein the workpiece position monitoring device (14) is a sensor unit (16) for contactless workpiece position monitoring.

2. The device as claimed in claim 1, wherein the workpiece position monitoring device (14) is additionally a centering and fixing unit.

3. The device as claimed in claim 1, wherein it is part of a pressing unit or of a bodyshell-welding unit.

4. The device as claimed in claim 1, wherein the sensor unit (16) is an optical sensor unit, in particular an infrared sensor unit.

5. The device as claimed in claim 1, wherein the sensor unit (16) has a plurality of spaced-apart sensor elements (20).

6. The device as claimed in claim 5, wherein at least two sensor elements (20) arranged in a common plane are provided for workpiece position detection.

7. The device as claimed in claim 5, wherein the sensor element (20) is designed as a nondestructively replaceable structural element.

8. The device as claimed in claim 5, wherein the sensor element (20) in each case has an L-shaped workpiece contact side (22) with which a sensor detection line (24) forms a triangle.

9. The device as claimed in claim 7, wherein the sensor element (20) has at least one hardened workpiece contact face (26).

10. The device as claimed in claim 7, wherein the sensor element (20) is a standard element.

11. The device as claimed in claim 1, wherein the sensor unit (16) is connected to an electronic data processing device and/or to a control device.
